(19) United States
(12) Patent Application Publication
(10) Pub. No.: US 2023/0285856 A1
(43) Pub. Date: Sep. 14, 2023

(54) VIDEO PLAYING METHOD AND APPARATUS, TERMINAL, AND STORAGE MEDIUM

(71) Applicant: TENCENT TECHNOLOGY (SHENZHEN) COMPANY LIMITED, Shenzhen (CN)

(72) Inventors: Jialu ZHANG, Shenzhen (CN); Huilin LIANG, Shenzhen (CN); Jun ZHANG, Shenzhen (CN); Chuan LV, Shenzhen (CN); Tao CAO, Shenzhen (CN); Bailu LI, Shenzhen (CN); Ling QIN, Shenzhen (CN)

(21) Appl. No.: 18/319,018

(22) Filed: May 17, 2023

Related U.S. Application Data
(63) Continuation of application No. PCT/CN2022/119695, filed on Sep. 19, 2022.

(30) Foreign Application Priority Data
Oct. 15, 2021 (CN) 202111204151.5

(51) Int. Cl. A63F 13/52; A63F 13/53; A63F 13/40; G06F 3/0486

(52) U.S. Cl. CPC A63F 13/52; A63F 13/53; A63F 13/40; G06F 3/0486

(57) ABSTRACT

A video playing method includes: displaying a windowed playing control in an out-battle scene interface, the out-battle scene interface being a scene interface of a game other than a battle interface of the game; displaying, in response to a trigger operation on the windowed playing control in the out-battle scene interface, a video playing window on an upper layer of the out-battle scene interface, the first video being played in the video playing window; and closing the video playing window when switching from the out-battle scene interface to the battle interface.

### CROSS-REFERENCES TO RELATED APPLICATIONS

This application is a continuation application of PCT Patent Application No. PCT/CN2022/119695, entitled “VIDEO PLAYING METHOD AND APPARATUS, AND TERMINAL, STORAGE MEDIUM AND PROGRAM PRODUCT” and filed on Sep. 19, 2022, which claims priority to Chinese Patent Application No. 202111204151.5, entitled “VIDEO PLAYING METHOD AND APPARATUS, TERMINAL, STORAGE MEDIUM, AND PROGRAM PRODUCT” filed on Oct. 15, 2021, the entire contents of both of which are incorporated herein by reference.

### FIELD OF THE TECHNOLOGY

Embodiments of the present disclosure relate to the field of human-computer interaction technologies, and in particular to a video playing method and apparatus, a terminal, a storage medium, and a program product.

### BACKGROUND OF THE DISCLOSURE

In a multiplayer online battle arena (MOBA) game, an out-battle scene refers to a game environment outside a round of battle in the MOBA game, and a player can learn about game knowledge, gain various benefits such as hero skins, prepare for battles, contact and make friends with other players, etc. outside the battle; a battle scene refers to a world in which a battle game at certain game level is played, in which a player controls a hero game character to fight, unleash skills, strive for victory, etc.

In related art, in an out-battle environment, a playing interface for game-related videos is provided for users. In response to that a user needs to watch a game-related video, the user can access a video playing interface through the playing interface to play the game-related video.

However, in related art, when the game-related video is played during a game, it is required to stay in the video playing interface at all times, and switching to other out-battle scene interfaces is not allowed.

### SUMMARY

Embodiments of the present disclosure provide a video playing method and apparatus, a terminal, a storage medium, and a program product. The technical solutions are as follows:

According to one aspect of the present disclosure, provided is a video playing method, executed by a terminal, the method including: displaying a windowed playing control in an out-battle scene interface, the out-battle scene interface being a scene interface of a game other than a battle interface of the game; displaying, in response to a trigger operation on the windowed playing control in the out-battle scene interface, a video playing window on an upper layer of the out-battle scene interface, a first video being played in the video playing window; and closing the video playing window when switching from the out-battle scene interface to a battle interface.

According to another aspect of the present disclosure, provided is a video playing apparatus, including: a first display module, configured to display a windowed playing control in an out-battle scene interface, the out-battle scene interface being a scene interface of a game other than a battle interface of the game; a second display module, configured to display, in response to a trigger operation on the windowed playing control in the out-battle scene interface, a video playing window on an upper layer of the out-battle scene interface, a first video being played in the video playing window; and a first control module, configured to close the video playing window when switching from the out-battle scene interface to a battle interface.

According to another aspect of the present disclosure, provided is a terminal, including at least one processor and at least one memory, the memory storing at least one program, and the at least one program being loaded and executed by the at least one processor to implement the video playing method described in the above aspect.

According to another aspect of the present disclosure, provided is a non-transitory computer-readable storage medium, having at least one instruction, at least one program, a code set or an instruction set stored thereon, the at least one instruction, the at least one program, the code set or the instruction set being loaded and executed by at least one processor to implement the video playing method described in the above aspect.

In a game scene, by providing a windowed video playing function for a video playing resource in an out-battle scene interface, a first video can be played through a video playing window. A feasible method is provided for a user to play a video during a game, and there is no need to keep a full-screen video playing interface at all times. Moreover, by playing the video in the video playing window, the influence on the user's related operation in the out-battle scene interface during video playing can be reduced. In addition, after entering a battle interface, the video playing window will be closed to avoid the influence of video playing on a game battle process.

### BRIEF DESCRIPTION OF THE DRAWINGS

FIG. 1 is a flowchart of a video playing method provided by one exemplary embodiment of the present disclosure.

FIG. 2 is a schematic diagram of a video playing process shown in one exemplary embodiment of the present disclosure.

FIG. 3 is a flowchart of a video playing method provided by another exemplary embodiment of the present disclosure.

FIG. 4 is a schematic diagram of display of a first video shown by another exemplary embodiment of the present disclosure.

FIG. 5 is a schematic diagram of a video playing process shown in another exemplary embodiment of the present disclosure.

FIG. 6 is a schematic diagram of a closing process of a video playing window shown by one exemplary embodiment of the present disclosure.

FIG. 7 is a flowchart of a video playing method provided by another exemplary embodiment of the present disclosure.

FIG. 8 is a schematic diagram of a video switching process shown in one exemplary embodiment of the present disclosure.

FIG. 9 is a flowchart of a video playing method provided by another exemplary embodiment of the present disclosure.

FIG. 10 is a schematic diagram of the display position of a video playing window shown by one exemplary embodiment of the present disclosure.

FIG. 11 is a schematic diagram of an enlarging process of a video playing window shown by one exemplary embodiment of the present disclosure.

FIG. 12 is a schematic diagram of a shrinking process of a video playing window shown by one exemplary embodiment of the present disclosure.

FIG. 13 is a schematic diagram of an updating process of the corresponding control size of a function control shown in one exemplary embodiment of the present disclosure.

FIG. 14 is a flowchart of a video playing method provided by another exemplary embodiment of the present disclosure.

FIG. 15 is a schematic diagram of a window position updating process of a video playing window shown by one exemplary embodiment of the present disclosure.

FIG. 16 is a schematic diagram of a window position updating process of a video playing window shown by another exemplary embodiment of the present disclosure.

FIG. 17 is a schematic diagram of a video full-screen mode shown by one exemplary embodiment of the present disclosure.

FIG. 18 is a schematic diagram of video playing modules involved in a video playing process shown by one exemplary embodiment of the present disclosure.

FIG. 19 is a schematic diagram of a window scaling process in a window interaction mode.

FIG. 20 is a structural block diagram of a video playing apparatus provided by one exemplary embodiment of the present disclosure.

FIG. 21 is a structural block diagram of a terminal provided by one exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

First, a brief introduction to terms involved in embodiments of the present disclosure is listed as follows:
Out-battle: an environment outside a battle in a game. A user can learn about game knowledge, gain hero skins, prepare for battle, contact and make friends with other users, etc. in an out-battle scene, and out-battle is the support and assistance of the game. In the embodiments of the present disclosure, an out-battle scene interface is an interface for displaying an out-battle scene. For example, the out-battle scene interface may be: a hero skin viewing interface, a game video watching interface, a game streaming watching interface, a friend communication interface, a lineup matching interface, etc.
Battle: a world in which a game is played at different game levels, in which a user can control a hero game character to, unleash skills, strive for victory, etc. The battle is the core experience of the game. In some embodiments, a battle interface is an interface that displays a battle scene, such as a battle participating interface, which may include a battle matching interface, a role selection interface (an interface for selecting to participate in a battle), and a battle display interface (for displaying a process of the user participating in the battle), or a battle spectating interface, i.e., an interface for the user spectating friends or other users participating in the battle.

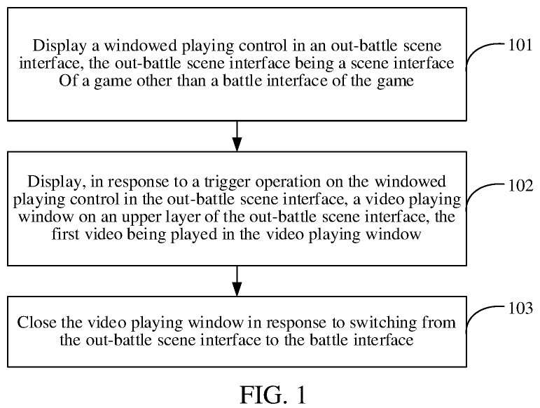

FIG. 1 is a flowchart of a video playing method provided by one exemplary embodiment of the present disclosure. Explanation is made by using an example where the execution subject of the method is a terminal. The method includes the following steps:

Step 101: Display a windowed playing control in an out-battle scene interface, the out-battle scene interface being a scene interface of a game other than a battle interface of the game. In some embodiments, the windowed playing control is displayed when there is a video playing resource of a first video in the out-battle scene interface.

During a game, in addition to participating in a battle, a user can also learn about game knowledge, gain hero skins, prepare for battle, contact and make friends with other users, etc. outside the battle. Besides, an out-battle scene also provides game-related video resources, such as game streaming, a battle lineup recommendation video, a hero skin display video, etc. However, when the user needs to watch said game-related videos during the game, it is usually required to keep a full-screen video playing interface at all times until video playing is completed, such that other game-related operations cannot be performed during the video playing process, resulting in a high time cost of video playing during the game process.

In order to improve the usability and watching efficiency of video playing during the game process, the embodiment of the present disclosure provides the function of using the video playing window to play the game video during the game process. The video playing window may not affect display of the out-battle scene interface of the game itself during the process of playing the video, so that the user can perform the game-related operation in the out-battle scene interface while watching the game-related video. The video playing in the video playing window will not be affected during switching between different out-battle scene interfaces.

Since various types of videos, such as online videos and local videos, are involved in the game process, in order to meet the need of the user to watch different types of videos in the out-battle scene interface, in one embodiment, different types of video playing resources are provided with windowed playing controls. The windowed playing control is configured to trigger the use of the video playing window to play the video. That is, upon detection that the video playing resource of the first video exists in the out-battle scene interface, the terminal displays the windowed playing control in the out-battle scene interface, so that the user can trigger a window playing function for the video through the windowed playing control.

For example, taking MOBA games as an example, the out-battle scene interface where the video playing resource exists may be a preparation center interface during the game process, and correspondingly, the first video may be the lineup recommendation video; the out-battle scene interface may also be an event TV interface, and correspondingly, the first video may be a live video of various events; the out-battle scene interface may also be a micro-community interface, and correspondingly, the first video may be a gameplay guide video for various heroes; the out-battle scene interface may also be a short video interface, and correspondingly, the first video may be a gameplay teaching video of different game streamers. The out-battle scene interface and the specific video displayed in the out-battle scene interface are not limited in the embodiment of the present disclosure.

In some embodiments, the display position of the windowed playing control may be associated with the first video. That is, after the user taps the windowed playing control, the terminal may be explicitly configured to play the first video in the video playing window. For example, the windowed playing control may be displayed in the lower right corner, the upper left corner, the lower left corner, the upper right corner, or other positions of the first video. The embodiment of the present disclosure does not limit the display position of the windowed playing control.

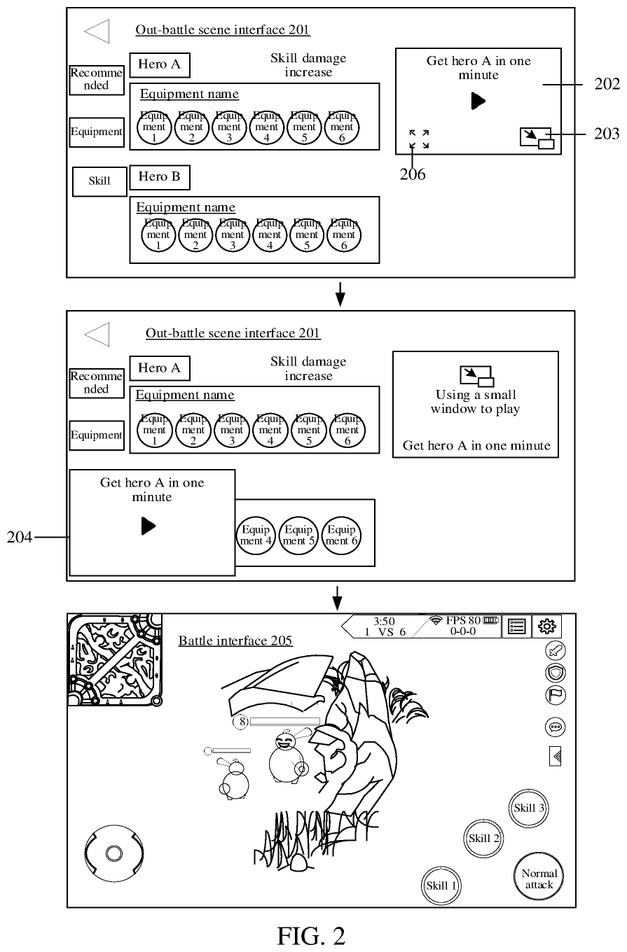

FIG. 2 is a schematic diagram of a video playing process shown in one exemplary embodiment of the present disclosure. Taking the out-battle scene interface being a virtual character recommendation interface as an example, a video playing resource of a first video 202 exists in an out-battle scene interface 201, and a windowed playing control 203 is displayed in the lower right corner of the first video 202. In some embodiments, a full-screen control 206 is displayed in the lower left corner of the first video 202, and the full-screen control 206 is configured to trigger full-screen display of the first video 202.

Step 102: Display, in response to a trigger operation on the windowed playing control in the out-battle scene interface, a video playing window on an upper layer of the out-battle scene interface, the first video being played in the video playing window.

In one embodiment, in response to that the user needs to play the first video through the video playing window, the user may tap the windowed playing control. Correspondingly, the terminal receives the trigger operation on the windowed playing control in the out-battle scene interface, displays the video playing window on the upper layer of the out-battle scene interface, and plays the first video in the video playing window.

As shown in FIG. 2, when the user needs to use the video playing window to play the first video 202, the user may tap the windowed playing control 203 corresponding to the first video 202, and correspondingly, the terminal receives the trigger operation on the windowed playing control 203 and displays the video playing window 204 at in the lower left corner of the out-battle scene interface 201. The first video 202 is displayed in the video playing window 204.

In some embodiments, when the first video is played in the video playing window, the video playing resource of the first video displayed in the out-battle scene interface can be closed.

In some embodiments, when the first video is played in the video playing window, the user can implement switching between different out-battle scene interfaces. Moreover, during the out-battle scene interface switching process, the video playing window may be displayed on the upper layers of different out-battle scene interfaces and play the first video, such that the user can perform game-related operations, for example, contact and making friends, implement lineup matching, and watch other game-related information, in other out-battle scene interfaces while watching the first video.

In some embodiments, in order to avoid the video playing window from blocking the out-battle scene interface, affecting the user's operation, the video playing window may be displayed in the corner of the out-battle scene interface or in the corner of the terminal display screen, for example, in the upper left corner, the upper right corner, the lower right corner, and the lower left corner of the terminal display screen. The embodiment of the present disclosure does not limit the display position of the video playing window.

In some embodiments, since the use of the video playing window is essentially to enable the user to perform other out-battle operations while watching the video, the display size of the video playing window is smaller than that of the terminal display screen, to avoid completely blocking the out-battle scene interface.

The display of the video playing window in the embodiment of the present disclosure does not depend on a video windowing function provided by a terminal system, instead, the video windowing function is provided by a target application (the application to which the out-battle scene interface belongs). Therefore, compared with video windows in related art, the video playing window provided in the embodiment of the present disclosure can provide more additional functions, such as video switching, volume control, video related information display, addition of videos to favorites, etc., which are to be described in the following embodiments.

In one embodiment, the target application decodes the first video by calling an FFmpeg library, updates image frames obtained after decoding and displays same into an image display component (such as a RawImage component) of a game engine (such as a Unity engine), thereby implementing the video playing function of the video playing window (bound to the image display component). Moreover, since the video displayed by calling the game engine can be naturally integrated into a game GUI hierarchical management system, no additional screen match is required, thereby improving the development efficiency.

Step 103: Close the video playing window when switching from the out-battle scene interface to a battle interface.

The purpose of using video playing window to play the video is to improve the efficiency of the user watching the video in the out-battle scene and to avoid the influence of the video playing window on a game battle (the main game process). In one embodiment, during entering the battle interface, that is, during switching from the out-battle scene interface to the battle interface, the terminal closes the video playing window and stops playing the first video through the video playing window.

As shown in FIG. 2, after switching from the out-battle scene interface 201 to a battle interface 205, the terminal does not display the video playing window 204 in the battle interface 205.

The video playing window in the embodiment of the present disclosure is a video playing component of the game itself, rather than the video playing window called from the terminal system. Therefore, the video playing window in the embodiment of the present disclosure may be automatically closed when entering a game battle process, so as to avoid affecting the main game process.

To sum up, in the embodiment of the present disclosure, by providing a windowed video playing function for a video playing resource in an out-battle scene interface, a first video can be played in a video playing window. A feasible method is provided for a user to play a video during a game, and there is no need to keep a full-screen video playing interface at all times. Moreover, by playing the video in the video playing window, the influence on the user's related operation in the out-battle scene interface during video playing can be reduced. In addition, after entering a battle interface, the video playing window will be closed to avoid the influence of video playing on a game battle process.

In order to avoid the influence of the process of the video playing window on the main game process (the battle process), the terminal controls the video playing window hierarchically and sets closing rules. That is to say, when receiving a battle entering instruction, the video playing window is closed in advance to ensure that the game battle process does not change.

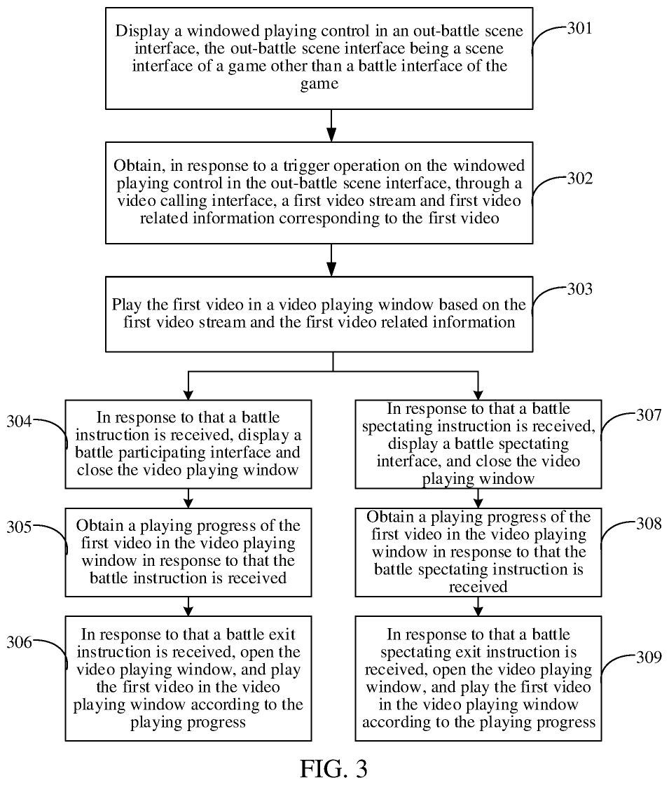

In an exemplary example, FIG. 3 is a flowchart of a video playing method provided by another exemplary embodiment of the present disclosure. Explanation is made by using an example where the execution subject of the method is a terminal. The method includes the following steps:

Step 301: Display a windowed playing control in an out-battle scene interface, the out-battle scene interface being a scene interface of a game other than a battle interface of the game. In some embodiments, the windowed playing control is displayed when there is a video playing resource of a first video in the out-battle scene interface.

Refer to step 101 for the implementation of step 301. The details are not described again in this embodiment.

Step 302: Receive, in response to a trigger operation on the windowed playing control in the out-battle scene interface, through a video calling interface, a first video stream and first video related information corresponding to the first video.

The difference between a video playing window in the embodiment of the present disclosure and a small playing window (picture-in-picture) of the terminal system is as follows: The video playing window is a video playing component of a game application itself and has the capability of obtaining a game-related video from the game application, and a developer can add a customized function to the video playing component (because the developer cannot customize the small playing window of the terminal system, the playing effect achieved by different applications by means of the small window playing function provided by the terminal system are exactly the same).

In one embodiment, when a terminal receives the trigger operation on the windowed playing control in the out-battle scene interface, the first video stream corresponding to the first video can be obtained through the video calling interface corresponding to the video playing window, and the first video related information corresponding to the first video can be obtained, so that the first video can be played in the video playing window, and the first video related information video is displayed in the video playing window.

In some embodiments, display of video related information may be a customized function added by the developer to the video playing component. In response to that no video related information display function is added, the video playing window may only obtain the first video stream corresponding to the first video.

In some embodiments, the first video related information may be a video title corresponding to the first video, a video producer, an avatar corresponding to the video producer, etc. The embodiment of the present disclosure does not limit the first video related information.

In some embodiments, when the first video is a local video of a game application, the first video stream and the first video related information corresponding to the first video may be obtained from a local game video database through the video calling interface; when the first video is an online video, such as a live video, a background server of the game application pulls from a game streaming platform the first video stream and feeds same back to the terminal, and correspondingly, the terminal receives the first video stream and the first video related information through the video calling interface.

Step 303: Play the first video in the video playing window based on the first video stream and the first video related information.

In one embodiment, the terminal plays the first video in the video playing window based on the first video stream, and displays the first video related information of the first video in the video playing window.

In some embodiments, in the process of playing the first video in the video playing window, the first video related information may not be displayed by default. When the user needs to view the first video related information of the first video, the user can tap the first video in the video playing window, and then the terminal receives the trigger operation for the first video in the video playing window and displays the first video related information in the video playing window.

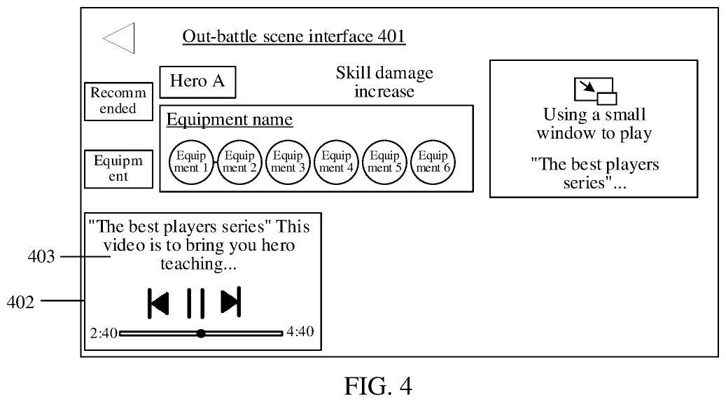

FIG. 4 is a schematic diagram of display of a first video shown by another exemplary embodiment of the present disclosure. A video playing window 402 is displayed in an out-battle scene interface 401. Besides the first video, video related information 403 is also displayed in the video playing window 402.

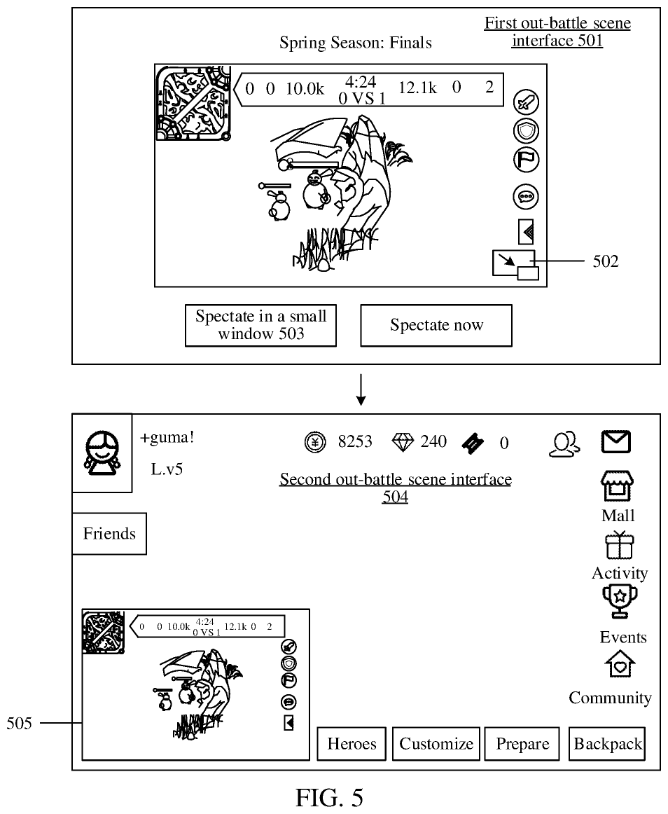

FIG. 5 is a schematic diagram of a video playing process shown in another exemplary embodiment of the present disclosure. Taking video streaming as an example, when a video resource related to a live video exists in a first out-battle scene interface 501, and a windowed playing control 502 is displayed in the lower right corner of the video resource, the user may tap the windowed playing control 502, such that a video playing window 505 is displayed in a second out-battle scene interface 504 while returning to the out-battle scene interface 504, and the live video is displayed in the video playing window 505. In some embodiments, a small window spectating control 503 is further provided for the live video. The user may also tap the small window spectating control 503 to return to the second out-battle scene interface 504 and display the video playing window 505.

Step 304: In response to that a battle instruction is received, display a battle participating interface and close the video playing window.

In some embodiments, during a game process, a battle interface at least includes a battle participating interface and a battle spectating interface. The battle participating interface is a related interface involved in a process of controlling, by the user, a virtual object participating in a battle, and the battle spectating interface is a related interface involved in a process of the user spectating other users participating in the battle.

In one embodiment, after the terminal receives a battle instruction, it indicates that it is about to enter the battle participating interface, and therefore, in order to avoid the influence of the video playing window on the main battle process, it is necessary to close the video playing window in time.

In some embodiments, taking MOBA games as an example, the battle instruction may be a battle matching completion instruction transmitted by a server to the terminal after battle matching is completed, for example, in a 5v5 battle mode, a matching interface is opened, and after matching is completed, the video playing window is automatically closed; and the battle instruction may also be a virtual character selection operation, indicating that the user needs to select a virtual character that is to participate in the battle, and correspondingly, the terminal receives the battle instruction, for example, when directly selecting the virtual character that is to participate in the battle in a 1v1 battle mode, the video playing window is automatically closed.

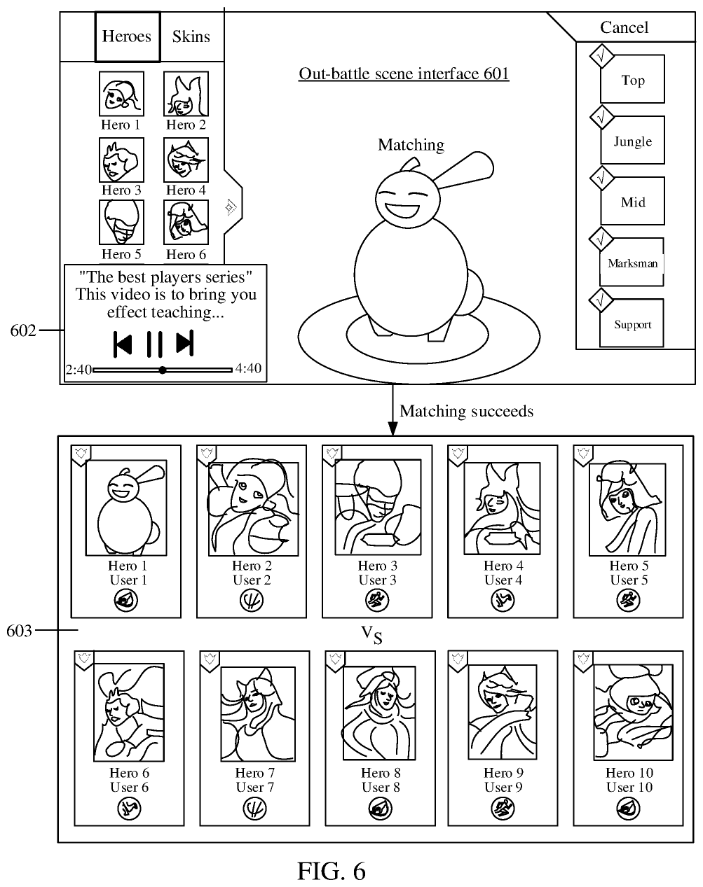

FIG. 6 is a schematic diagram of a closing process of a video playing window shown by one exemplary embodiment of the present disclosure. Taking an out-battle scene interface 601 being a battle matching interface as an example, the battle matching interface is an interface before matching is completed. A video playing window 602 is displayed in the out-battle scene interface 601, such that the user can watch a game-related video during the matching process, thereby improving the time utilization rate. After the matching succeeds, indicating that it is about to enter a battle, the out-battle scene interface 601 is switched to a battle loading interface 603, and the video playing window 602 is closed.

Step 305: Obtain a playing progress of the first video in the video playing window in response to that the battle instruction is received.

When waiting for the successful battle matching, the user may play the first video of interest through the video playing window, and after the matching succeeds, the video playing window will be closed immediately, in which case the playing of the first video that the user is interested in may not be completed when the matching succeeds. Therefore, to avoid searching for the first video again and adjusting the playing progress of the first video when the user still wants to continue to watch the first video after the battle is over, in one embodiment, after receiving the battle instruction, the terminal may obtain the playing progress of the first video in the video playing window, so as to resume the playing process of the first video after exiting the battle.

For example, in response to that the first video has been played for 1 minute and 30 seconds after the terminal receives the battle instruction, the playing progress is 00:01:30.

After receiving the battle instruction, the terminal may record the playing progress of the first video and close the video playing window at the same time.

Step 306: In response to that a battle exit instruction is received, open the video playing window, and play the first video in the video playing window according to the playing progress.

In order to improve the efficiency for the user to continue to watch the first video, in one embodiment, after receiving the battle exit instruction, the terminal opens the video playing window and plays the first video again in the first video playing window, to avoid the situation where the user needs to switch to the out-battle scene interface where the video playing resource corresponding to the first video exists. The battle exit instruction may be triggered by the server at the end of the battle, or may be manually triggered by the user during the battle (that is, the battle is ended halfway). This is not limited in the embodiment of the present disclosure.

In some embodiments, the terminal has recorded the playing progress of the first video before entering the battle. In order to avoid the situation where the user further needs to adjust the playing progress of the first video in the video playing window or to watch some video clips of the first video repeatedly, in one embodiment, the video playing progress of the first video is resumed in the video playing window.

Step 307: In response to that a battle spectating instruction is received, display a battle spectating interface, and close the video playing window.

In some embodiments, the battle interface may also be the battle spectating interface, and the battle spectating interface refers to an interface allowing watching of battles of other users.

In one embodiment, in response to that the user needs to watch a battle process of a friend, the user may tap a battle spectating control, and after receiving the battle spectating instruction, the corresponding terminal will close the video playing window while entering the battle spectating interface.

Step 308: Obtain a playing progress of the first video in the video playing window in response to that the battle spectating instruction is received.

To avoid searching for the first video again and adjusting the playing progress of the first video when the user still wants to continue to watch the first video after the battle spectating is over, in one embodiment, after receiving the battle spectating instruction, the terminal may obtain the playing progress of the first video in the video playing window, so as to resume the playing process of the first video after exiting the battle spectating.

After receiving the battle spectating instruction, the terminal may record the playing progress of the first video and close the video playing window at the same time.

Step 309: In response to that a battle spectating exit instruction is received, open the video playing window, and play the first video in the video playing window according to the playing progress.

In order to improve the efficiency for the user to watch the first video again, in one embodiment, after receiving the battle spectating exit instruction and returning to the out-battle scene interface, the terminal may open the video playing window and play the first video again in the first video playing window, to avoid the situation where the user needs to switch to the out-battle scene interface where the video playing resource corresponding to the first video exists. The battle spectating exit instruction may be triggered by the server at the end of the spectated battle, or may be manually triggered by the user during the battle spectating (that is, the battle spectating is ended halfway). This is not limited in the embodiment of the present disclosure.

In some embodiments, the terminal has recorded the playing progress of the first video before entering the battle spectating. In order to avoid the situation where the user further needs to adjust the playing progress of the first video in the video playing window or to watch some video clips of the first video repeatedly, in one embodiment, the video playing progress of the first video is resumed in the video playing window.

In this embodiment, since the video playing window is a playing component of the game application itself, the video playing window can obtain the video resource from the game application. At the same time, in order to avoid the influence of the video playing window on the game application itself, the video playing window may be automatically closed when the game enters the main process (the battle process).

In addition, before entering the battle, the current playing progress of the video is recorded, so that when exiting the battle subsequently, the video that has not been completely played before entering the battle can be continuously played based on the recorded playing progress, thereby avoiding searching for the video again and manually adjusting the video playing progress after exiting the battle, and thus improving the video playing convenience.

Since the video playing window is a playing component of the game application itself, the video playing window has the permission to obtain the video resource from the game application Therefore, in one embodiment, the user may implement switching between different videos directly through the video playing window, thereby avoiding the process of returning to the original out-battle scene interface and reselecting the video resource, and thus improving the video switching efficiency.

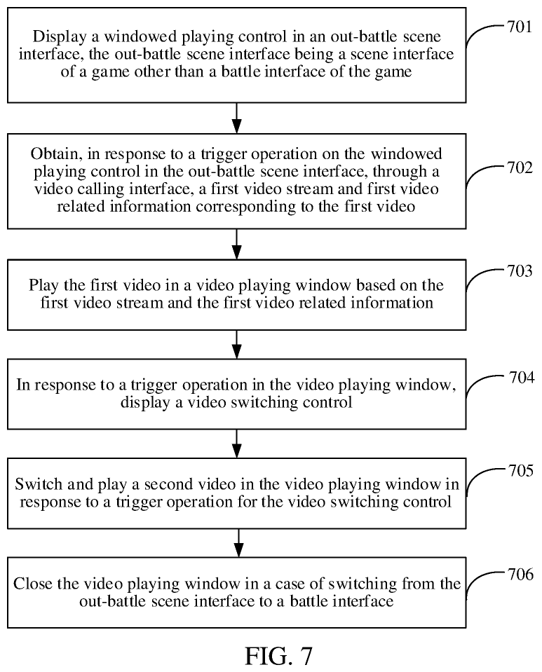

FIG. 7 is a flowchart of a video playing method provided by another exemplary embodiment of the present disclosure. Explanation is made by using an example where the execution subject of the method is a terminal. The method includes the following steps:

Step 701: Display a windowed playing control in an out-battle scene interface, the out-battle scene interface being a scene interface of a game other than a battle interface of the game.

Step 702: Obtain, in response to a trigger operation on the windowed playing control in the out-battle scene interface, through a video calling interface, a first video stream and first video related information corresponding to the first video.

Step 703: Play the first video in the video playing window based on the first video stream and the first video related information.

Refer to the above embodiments for the implementations of step 701 to step 703. The details are not described again in this embodiment.

Step 704: In response to a trigger operation in the video playing window, display a video switching control.

In some embodiments, during the process of playing the first video in the video playing window, only the video picture of the first video is displayed in the video playing window by default, and video related information such as a function control or a video title is not displayed. That is, no UI is displayed in the video playing window by default.

In one embodiment, in response to that the user needs to switch videos, the user may tap a video area in the video playing window. The corresponding terminal receives the trigger operation in the video playing window to display the video switching control in the video playing window. In some embodiments, the terminal may determine whether the terminal has received the trigger operation in the video playing window by detecting a position of an operation focus.

In some embodiments, the trigger operation in the video playing window may be any one of a tap operation, a double tap operation, a swipe operation, a long press operation, etc. The embodiment of the present disclosure does not limit the trigger operation.

In some embodiments, the video switching control may be configured for switching to the next video or switching to the previous video.

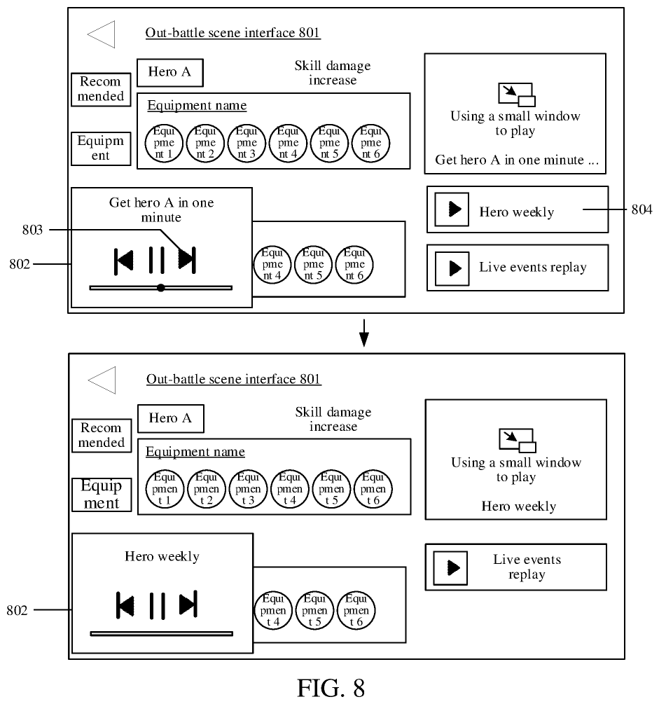

In one embodiment, the first video related information includes a video list, and in response to the trigger operation in the video playing window, the terminal displays the video switching control based on the video list. In response to that the video list indicates the existence of the previous video corresponding to the first video, a first video switching control (configured for switching to the previous video) is set to a triggerable state; in response to that the video list indicates the inexistence of the previous video corresponding to the first video, the first video switching control is set to an untriggerable state; in response to that the video list indicates the existence of the next video corresponding to the first video, a second video switching control (configured for switching to the next video) is set to the triggerable state; in response to that the video list indicates the inexistence of the next video corresponding to the first video, the second video switching control is set to the untriggerable state. FIG. 8 is a schematic diagram of a video switching process shown in one exemplary embodiment of the present disclosure. A video playing window 802 is displayed in an out-battle scene interface 801, and a video switching control 803 is displayed in the video playing window 802. When the user taps the video switching control 803, the terminal receives a trigger operation on the video switching control 803 and determines to switch to the next video, and then direct switching to display of a video 804 can be implemented in the video playing window 802.

In some embodiments, besides the video switching control, the first video related information of the first video, such as a video title and producer information, may also be displayed in the video playing window. A windowed playing exit control, a window closing control, a pausing/playing control, a playing to adjusting control, etc. can also be displayed. The embodiment of the present disclosure does not limit the function controls displayed in the video playing window.

Step 705: Switch and play a second video in the video playing window in response to a trigger operation on the video switching control.

The difference from the picture-in-picture mode of the terminal system, the video playing window in the embodiment of the present disclosure provides a video switching function. In one embodiment, when the user needs to switch to the next video or the previous video, the user may directly tap the video switching control in the video playing window, and the corresponding terminal receives the trigger operation on the video switching control and may switch to play the second video in the video playing window.

Since the video playing window in the present disclosure has the permission to obtain the video resource from the game application, the video playing window may obtain the switched video resource through a video switching instruction. In an exemplary example, step 705 may also include step 705A to step 705C.

Step 705A: Transmit, in response to the trigger operation on the video switching control, a video switching instruction through a video calling interface, the video switching instruction being used for obtaining a second video stream and second video related information corresponding to the second video.

In one embodiment, when receiving the trigger operation on the video switching control, the terminal determines video information to be switched, and then transmits the video switching instruction through the video calling interface. The video switching instruction is used for obtaining the video resource corresponding to the video to be switched, that is, obtaining the second video stream and the second video related information corresponding to the second video.

In some embodiments, when playing an online video, a target application transmits the video switching instruction to the server through the video calling interface; when playing a local video, the target application transmits the video switching instruction to a local video management server through the video calling interface.

Step 705B: Obtain the second video stream and the second video related information through the video calling interface.

In one embodiment, the terminal transmits the obtained second video stream and the second video related information to a corresponding playing component of the video playing window through the video calling interface, so that the video playing window may directly display the switched second video.

Step 705C: Play the second video in the video playing window based on the second video stream and the second video related information.

In one embodiment, the second video is played in the video playing window based on the second video stream, and the second video related information corresponding to the second video is displayed.

In some embodiments, in response to that the video playing window does not receive the second video related information, correspondingly, the second video related information is not displayed.

Step 706: Close the video playing window when switching from the out-battle scene interface to a battle interface.

Refer to the above embodiment for the implementation of step 706. The details are not described again in this embodiment.

In this embodiment, since the video playing window has the permission to obtain the video resource in the game, correspondingly, the video switching control is set in the video playing window, so that the user may directly switch to other videos in the video playing window without exiting the video playing window and reselecting other videos to play in the video playing window, which improves the video switching efficiency, then improves the video playing efficiency in the game.

In order to avoid the video playing window blocking the out-battle scene interface, when the terminal calls the video playing window, the video playing window is displayed in the corner of the screen by default. Moreover, the window size of the video playing window is determined by the display screen size corresponding to the current terminal to adapt to different terminals.

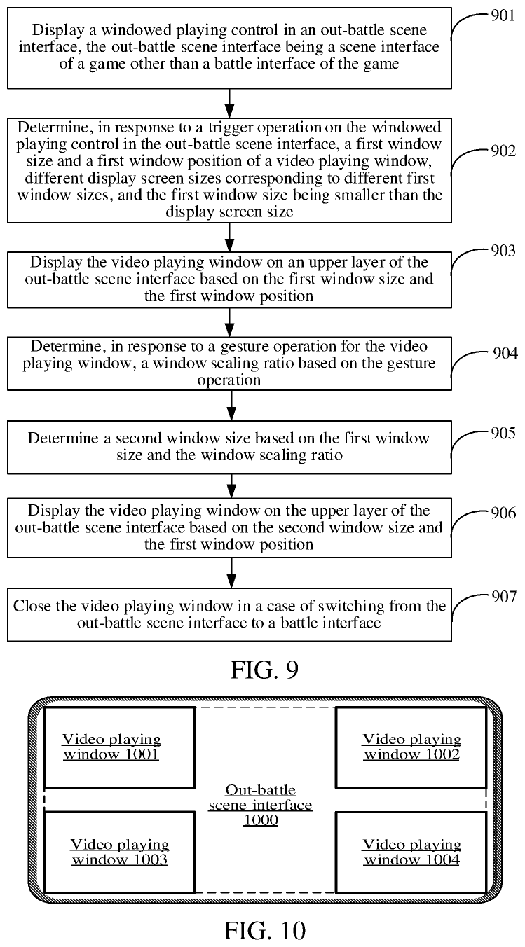

FIG. 9 is a flowchart of a video playing method provided by another exemplary embodiment of the present disclosure. Explanation is made by using an example where the execution subject of the method is a terminal. The method includes the following steps:

Step 901: Display a windowed playing control in an out-battle scene interface, the out-battle scene interface being a scene interface of a game other than a battle interface of the game. In some embodiments, the windowed playing control is displayed when there is a video playing resource of a first video associated with a current scenario in the out-battle scene interface.

Refer to the above embodiment for the implementation of step 901. The details are not described again in this embodiment.

Step 902: Determine, in response to a trigger operation on the windowed playing control in the out-battle scene interface, a first window size and a first window position of the video playing window, different display screen sizes corresponding to different first window sizes, and the first window size being smaller than the display screen size.

In one embodiment, when the terminal receives the trigger operation on the windowed playing control in the out-battle scene interface, the first window size and first window position of the video playing window are determined, so that the video playing window may be displayed based on the window size and the window position.

In order to minimize the blocking of the out-battle scene interface by the video playing window and thus reduce the influence of the video playing window on the user's operation in the out-battle scene interface in the video playing process, the first window size of the video playing window need to adapt to the current display screen size of the terminal, so that the first window size is smaller than the display screen size. In response to that the out-battle scene interface is displayed in the terminal in a full-screen mode, the blocking of the out-battle scene interface by the video playing window may be reduced.

In some embodiments, when the user calls the video playing window, the video playing window may use a minimum window size by default. In some embodiments, the minimum window size may be set by the developer, and to adapt to different terminals, different first window sizes may be set for terminals with different display screen sizes. In some embodiments, the terminal may adjust the first window size based on its own display screen size.

For example, the first window size may be set to ⅛ of the display screen size.

In some embodiments, since a function control in the out-battle scene interface is generally displayed in the middle of the interface, in order to avoid the video playing window blocking the function control in the out-battle scene interface and affecting the user's operation in the out-battle scene interface, in one embodiment, the video playing window is displayed in the corner area of the terminal display screen by default, that is, the first window position of the video playing window may be in the upper left corner, the upper right corner, the lower left corner, and the lower right corner of the display screen.

In some embodiments, since the target application controls the display in both the video playing window and the out-battle scene interface, the target application may also intelligently determine the position of the main control in the current out-battle scene interface, and then display the video playing window in a display area where the position of the main control is not blocked.

Step 903: Display the video playing window on an upper layer of the out-battle scene interface based on the first window size and the first window position.

In one embodiment, after the terminal determines the first window size and the first window position of the video playing window, the video playing window may be displayed on the upper layer of the out-battle scene interface. For example, in response to that the terminal determines that the first window size is 300 px×600 px, and the first window position is the lower left corner of the display screen, the terminal displays a 300 px×500 px video playing window in the lower left corner of the display screen and plays the first video in the video playing window.

FIG. 10 is a schematic diagram of a display position of a video playing window shown by one exemplary embodiment of the present disclosure. The terminal may display a video playing window 1001 in the upper left corner of an out-battle scene interface 1000 (the upper left corner of the terminal display screen), display a video playing window 1002 in the upper right corner of the out-battle scene interface 1000 (the upper right corner of the terminal display screen), display a video playing window 1003 in the lower left corner of the out-battle scene interface 1000 (the lower left corner of the terminal display screen), and display a video playing window 1004 in the lower right corner of the out-battle scene interface 1000 (the lower right corner of the terminal display screen).

Step 904: Determine, in response to a gesture operation for the video playing window, a window scaling ratio based on the gesture operation.

In order to make the window size of the video playing window meet the watching requirements of different users, in one embodiment, the user is allowed to scale the video playing window manually. The corresponding terminal receives the gesture operation for the video playing window, and determines the window scaling ratio based on the gesture operation, so as to change the window size of the video playing window.

The gesture operation may be a double contact point gesture operation: two fingers move away from each other to enlarge the video playing window, and the two fingers move close to each other to shrink the video playing window.

For the process of determining the window scaling ratio based on the gesture operation, in one embodiment, when a multiple-point touch signal is detected in the video playing window, the terminal monitors a distance change ratio between contact points corresponding to the touch signal in real time, and then determines the current window scaling ratio based on the relationship between the distance change ratio and the scaling ratio.

In some embodiments, the relationship between the distance change ratio and the window scaling ratio is preset in the terminal.

Step 905: Determine a second window size based on the first window size and the window scaling ratio.

In one embodiment, after the window scaling ratio is determined, the second window size of the video playing window may be updated in real time based on the first window size.

For example, if the window scaling ratio is: enlarge by 20%, and the first window size is 300 px×500 px, the corresponding second window size is 360 px×600 px.

In some embodiments, in the process of enlarging and shrinking the video playing window, in order to avoid the video playing window being too large to go beyond the area of the display screen or to block a large part of the out-battle scene interface, and to avoid the video playing window being too small to affect the video watching effect of the user, or to avoid the user's operation for the video playing window, in one embodiment, a first window size threshold and a second window size threshold are set, and the second window size needs to be greater than or equal to the first window size threshold and less than or equal to the second window size threshold.

The first window size threshold and the second window size threshold are set by the developer. In some embodiments, different first window size thresholds and second window size thresholds may be set for different types of terminals. For example, the first window size threshold may be 210 px, indicating that the minimum width of the video playing window is not less than 210 px; and the second window size threshold may be 670 px, indicating that the maximum width of the video playing window is not greater than 670 px.

Step 906: Display the video playing window on the upper layer of the out-battle scene interface based on the second window size and the first window position.

In one embodiment, the size of the video playing window is scaled along with a target gesture operation, and when the target gesture operation is over, the terminal displays the video playing window with the updated second window size at the first window position.

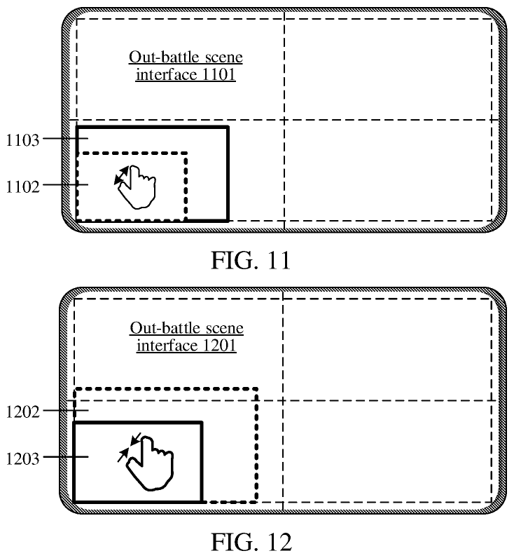

FIG. 11 is a schematic diagram of an enlarging process of a video playing window shown by one exemplary embodiment of the present disclosure. A video playing window 1102 is displayed in the lower left corner of an out-battle scene interface 1101. When the terminal receives an enlarging gesture operation for the video playing window (two fingers move away from each other along the arrow direction), the video playing window 1102 will be enlarged along with the enlarging gesture operation, until the video playing window is updated as a video playing window 1103.

FIG. 12 is a schematic diagram of a shrinking process of a video playing window shown by one exemplary embodiment of the present disclosure. A video playing window 1202 is displayed in the lower left corner of an out-battle scene interface 1201. When the terminal receives a shrinking gesture operation for the video playing window (two fingers move close to each other along the arrow direction), the video playing window 1202 will shrink along with the shrinking gesture operation, until the video playing window is updated as a video playing window 1203.

Step 907: Close the video playing window when switching from the out-battle scene interface to a battle interface.

Refer to the above embodiment for the implementation of step 907. The details are not described again in this embodiment.

In this embodiment, the user may customize the window size of the video playing window, and enlarge and shrink the window size of the video playing window through the target gesture operation, so that the video playing window can adapt to different terminals, can meet the requirements of different users for the window size of the video playing window, and can meet the personalized requirements of video playing during the game.

In one application scene, video-related function controls, such as a video switching control, a pausing/playing control, a replaying control, and a playing progress adjustment control, are also displayed in the video playing window, such that during adjusting the window size of the video playing window, it is also necessary to consider the operability of each function control.

In some embodiments, after the terminal determines the window size of the video playing window after a scaling operation, a control size of each function control can further be determined based on the second window size, so that the control size of the function control adapts to the window size of the current video playing window.

The control size is positively correlated with the second window size. That is to say, when the video playing window is enlarged, the control size of the function control also increases, and when the video playing window shrinks, the control size of the function control also decreases.

In some embodiments, different function controls may correspond to different control sizes, or may correspond to the same control size.

In some embodiments, in order to avoid that the control size is too small and then it is not beneficial to the operation of the user in the video playing window, a control size threshold is set, that is, the control size needs to be greater than the control size threshold. For example, the control size threshold may be 20 px, indicating that the minimum control width of the function control needs to be greater than 20 px.

In one embodiment, when the size of the video playing window is updated to the second window size, the video playing window does not display the function control by default. After receiving the trigger operation for the video playing window, the terminal may display each function control in the video playing window based on the target control size.

In some embodiments, the video playing window also displays video related information, such as the video title, and accordingly, when the window size of the video playing window changes, the number of words displayed in the video title also correspondingly adapts to the window size. The greater the window size, the more words are displayed. On the contrary, the smaller the window size, the fewer words are displayed.

FIG. 13 is a schematic diagram of an updating process of the corresponding control size of a function control shown in one exemplary embodiment of the present disclosure. A video playing window 1302 is displayed in an out-battle scene interface 1301, and a video title 1303 and a function control 1304 are displayed in the video playing window 1302. After enlarging the video playing window 1302, the number of title words in the video title 1303 displayed in the video playing window 1302 increases, and the control size of the function control 1304 increases.

In order to avoid the video playing window blocking the out-battle scene interface, the user is allowed to drag the video playing window to change the display position of the video playing window.

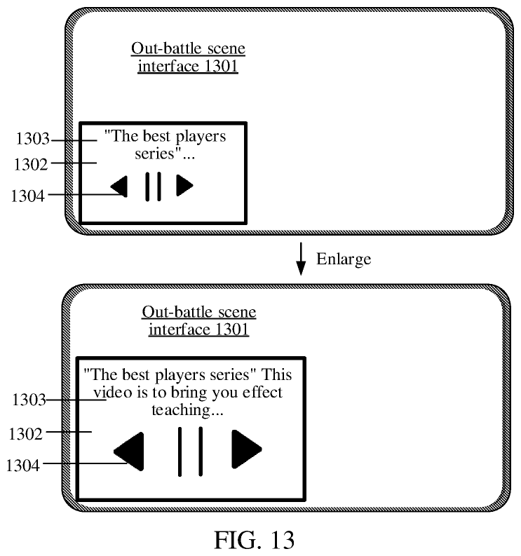

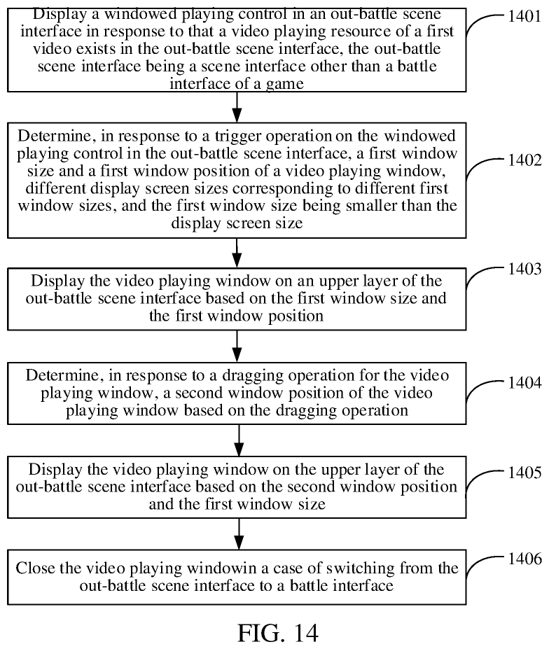

FIG. 14 is a flowchart of a video playing method provided by another exemplary embodiment of the present disclosure. Explanation is made by using an example where the execution subject of the method is a terminal. The method includes the following steps:

Step 1401: Display a windowed playing control in an out-battle scene interface, the out-battle scene interface being a scene interface of a game other than a battle interface of the game. In some embodiments, the windowed playing control is displayed when there is a video playing resource of a first video in the out-battle scene interface.

Step 1402: Determine, in response to a trigger operation on the windowed playing control in the out-battle scene interface, a first window size and a first window position of a video playing window, different display screen sizes corresponding to different first window sizes, and the first window size being smaller than the display screen size.

Step 1403: Display the video playing window on an upper layer of the out-battle scene interface based on the first window size and the first window position.

Refer to the above embodiments for the implementations of step 1401 to step 1403. The details are not described again in this embodiment.

Step 1404: Determine, in response to a dragging operation for the video playing window, a second window position of the video playing window based on the dragging operation.

In one embodiment, the video playing window is displayed in the corner of the screen by default. When the video playing window blocks a function control in the out-battle scene interface, the user may drag the video playing window to update the display position of the video playing window. The corresponding terminal receives the dragging operation for the video playing window, and determines the second window position of the video playing window based on the dragging operation.

In some embodiments, during the dragging process, the video playing window may be displayed at the position where the dragging operation stops; or the screen corner area where the video playing window needs to be currently displayed is determined based on the demand that the video playing window is displayed in the screen corner area. In one exemplary example, step 1404 may also include step 1404A and step 1404B.

Step 1404A: Determine, in response to the dragging operation for the video playing window, central position coordinates of the video playing window in response to that the dragging operation stops, the video playing window moving with the dragging operation.

In one embodiment, after the terminal receives the dragging operation for the video playing window, it is required to determine the touch position of the dragging operation in real time, and update the position of the video playing window based on the touch position, that is, the video playing window moves with the dragging operation. When the dragging operation stops, it is required to determine which screen corner area is to display the video playing window. By obtaining the central position coordinates of the video playing window when the dragging operation stops, which screen corner area the video playing window is to be adsorbed is determined based on the quadrant where the central position coordinates are located.

Step 1404B: Determine, based on a display area at the central position coordinates, the second window position corresponding to the video playing window, the second window position being located at a screen corner position corresponding to the display area.

Taking the central position of the terminal as the coordinate origin, the terminal display screen area is divided into four quadrants, that is, four candidate display areas.

In one embodiment, after the central position coordinates of the video playing window are determined, a target quadrant (display area) where the central position coordinates are located is determined, and then the video playing window is displayed in the corresponding screen corner position of the target display area.

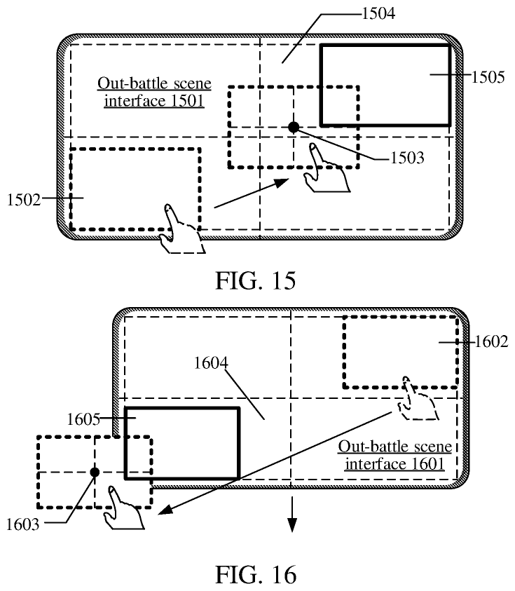

FIG. 15 is a schematic diagram of a window position updating process of a video playing window shown by one exemplary embodiment of the present disclosure. A video playing window 1502 is displayed in an out-battle scene interface 1501. When the user drags the video playing window 1502 in the arrow direction, a center position 1503 of the video playing window is in a display area 1504 in the upper right corner of the terminal display screen, and a video playing window 1505 is correspondingly displayed in the corner area in the upper right corner of the screen.

FIG. 16 is a schematic diagram of a window position updating process of a video playing window shown by another exemplary embodiment of the present disclosure. A video playing window 1602 is displayed in an out-battle scene interface 1601. When the user drags the video playing window 1602 in the arrow direction, a center position 1603 of the video playing window is in a display area 1604 in the lower left corner of the terminal display screen, and a video playing window 1605 is correspondingly displayed in the corner area in the lower left corner of the screen. Hence, even if the video playing window is dragged outside the display screen, as long as the central position coordinates are located in the quadrant, it is determined that the video playing window is dragged to the lower left display area, and is then correspondingly displayed at the lower left corner of the screen.

Step 1405: Display the video playing window on the upper layer of the out-battle scene interface based on the second window position and the first window size.

In one embodiment, after the terminal determines the second window position, the video playing window of the first window size is displayed at the display position indicated by the second window position.

Step 1406: Close the video playing window when switching from the out-battle scene interface to a battle interface.

Refer to the above embodiment for the implementation of step 1406. The details are not described again in this embodiment.

In this embodiment, the function for the user to change the display position of the video playing window is provided, so that the video playing window may change along with the user's dragging operation, thereby avoiding the video playing window from blocking the function control in the out-battle scene interface.

Different from video windows that depend on terminal systems, when an application to which a video in a video window belongs is switched from a foreground running state to a background running state, the video window still continues to display. In the embodiment of the present disclosure, since the video playing window depends on the game application, that is, the video playing window is not independent of the game application, when the game application (target application) is switched to the background running, the video playing window will also correspondingly stop displaying. In one embodiment, when the target application is switched from the foreground running state to the background running state, displaying of the video playing window stops. The target application is a game program that displays the out-battle scene interface.

In some embodiments, in response to that the target application is switched from the background running state to the foreground running state, it is available to continue to play the first video through the video playing window.

During the game, in addition to playing the game-related video through the video playing window, in other embodiments, the game-related video can also be played in a full-screen mode. In order to meet the needs of related users for watching the game video, the full-screen video playing window displays video related information (video title), the pausing/playing control, a playing timing control, a countdown control, a playing progress bar (a draggable progress bar), dotting display and a video playing control (configured for switching from a full-screen state to a video playing window display state).

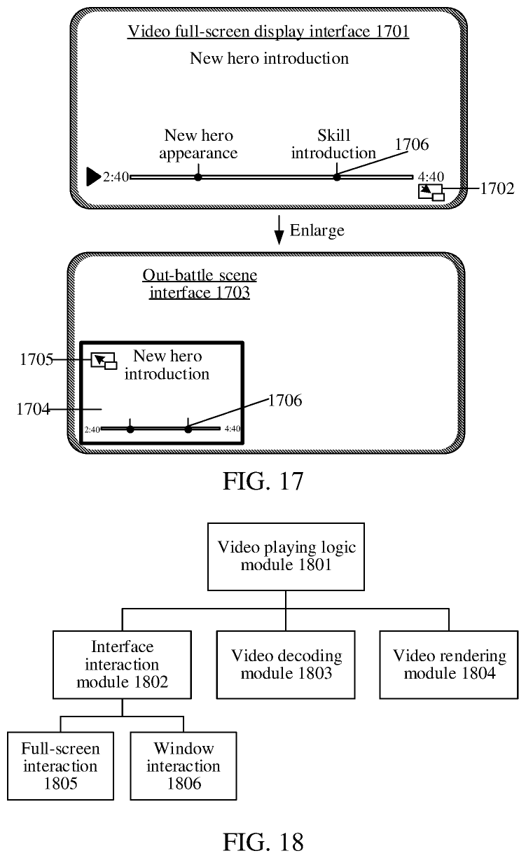

FIG. 17 is a schematic diagram of a video full-screen mode shown by one exemplary embodiment of the present disclosure. Video contents concerning new hero introduction are displayed in a video full-screen display interface 1701, dotting display controls 1706 are displayed on a progress bar, and by tapping the dotting display controls, direct jump to display new hero appearance and skill introduction chapters can be achieved. In some embodiments, a windowed playing control 1702 is further displayed in the video full-screen display interface 1701, the user can window a video playing control 1702, and a video playing window 1704 of the video is displayed in an out-battle scene interface 1703. In some embodiments, an exit window control 1705 is also displayed in the video playing window 1704, to exit a playing mode of playing the video in the video playing window. In some embodiments, the progress bar and the dotting display controls 1706 (scaled) are also displayed in the video playing window 1704.

Based on the video playing process shown in the embodiments above, video playing modules involved in the video playing process are as shown in FIG. 18. The video playing modules include a video playing logic module 1801, an interface interaction module 1802, a video decoding module 1803, and a video rendering module 1804. The interface interaction module 1802 includes full-screen interaction 1805 and window interaction 1806.

The video playing logic module 1801 is configured to maintain a video playing interface, manage an interface display level and a life cycle, organize video playing data, video links, use interactive types, dotting information, etc., process related logic, pause play, replay, switch videos, etc.

The interface interaction module 1802 is configured to complete display of interaction interfaces, such as a playing progress, a title, a current playing state, etc., and is also configured to receive and respond to user interaction information, for example, operating the playing progress, switching the playing state, switching the full-screen/window interaction mode, etc.

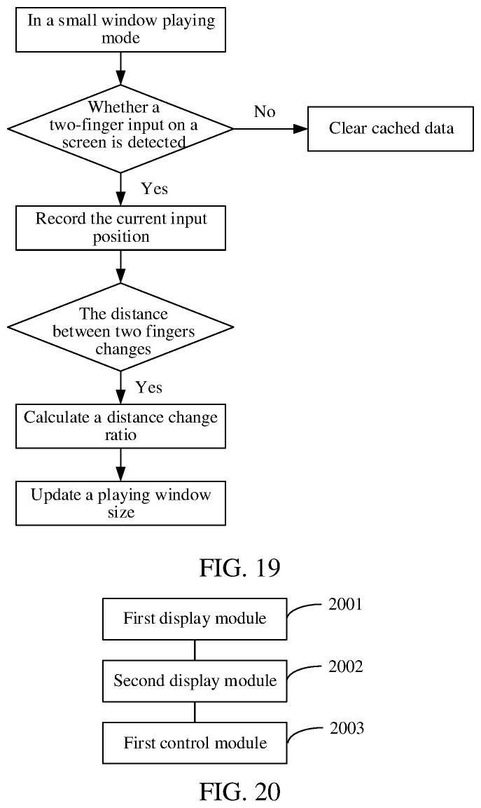

In an exemplary example, the window scaling process in the window interaction mode may be as shown in FIG. 19. In the small window playing mode, when a two-finger input is detected on the screen, the current input position will be recorded, the distance change ratio will be determined according to the change of the distance between the two fingers, and then the size of the playing window will be updated based on the distance change ratio. When no two-finger input is detected, cache data is cleared.

The video decoding module 1803 is configured to decode a video stream, and can flexibly control switching between hard decoding and soft decoding through a cloud control switch, achieving good balance between the adaptability and decoding efficiency of different terminal devices.

The video rendering module 1804 is configured to update decoded image frames and display same in the video playing window.

The following are apparatus embodiments of the present disclosure. For details not described in detail in the apparatus embodiments, please refer to the method embodiments above.

FIG. 20 is a structural block diagram of a video playing apparatus provided by one exemplary embodiment of the present disclosure. The apparatus includes:
a first display module 2001, configured to display a windowed playing control in an out-battle scene interface, the out-battle scene interface being a scene interface of a game other than a battle interface of the game;
a second display module 2002, configured to display, in response to a trigger operation on the windowed playing control in the out-battle scene interface, a video playing window on an upper layer of the out-battle scene interface, the first video being played in the video playing window; and
a first control module 2003, configured to close the video playing window when switching from the out-battle scene interface to a battle interface.

In some embodiments, the first control module 2003 includes:
a first control unit, configured to display a battle participating interface and close the video playing window in response to that a battle instruction is received.

In some embodiments, the apparatus further includes:
a first obtaining module, configured to obtain a playing progress of the first video in the video playing window in response to that the battle instruction is received.

The apparatus further includes:
a first playing module, configured to open the video playing window, and play the first video in the video playing window according to the playing progress in response to that a battle exit instruction is received.

In some embodiments, the first control module 2003 includes:
a second control unit, configured to display a battle spectating interface, and close the video playing window in response to that a battle spectating instruction is received.

In some embodiments, the apparatus further includes:
a second obtaining module, configured to obtain a playing progress of the first video in the video playing window in response to that the battle spectating instruction is received.

The apparatus further includes:
a second playing module, configured to open the video playing window, and play the first video in the video playing window according to the playing progress in response to that a battle spectating exit instruction is received.

In some embodiments, the second display module 2002 includes:
a first obtaining unit, configured to obtain, in response to a trigger operation on the windowed playing control in the out-battle scene interface, through a video calling interface, a first video stream and first video related information corresponding to the first video; and
a first playing unit, configured to play the first video in the video playing window based on the first video stream and the first video related information.

In some embodiments, the apparatus further includes:
a third display module, configured to display a video switching control in response to a trigger operation in the video playing window; and
a third playing module, configured to switch and play a second video in the video playing window in response to a trigger operation on the video switching control.

In some embodiments, the second playing module includes:
a transmitting unit, configured to transmit, in response to the trigger operation on the video switching control, a video switching instruction through a video calling interface, the video switching instruction being used for obtaining a second video stream and second video related information corresponding to the second video;
a second obtaining unit, configure to obtain the second video stream and the second video related information through the video calling interface; and
a second playing unit, configured to play the second video in the video playing window based on the second video stream and the second video related information.

In some embodiments, the second display module 2002 includes:
a first determining unit, configured to determine, in response to the trigger operation on the windowed playing control in the out-battle scene interface, a first window size and a first window position of the video playing window, different display screen sizes corresponding to different first window sizes, and the first window size being smaller than the display screen size; and
a display unit, configured to display the video playing window on the upper layer of the out-battle scene interface based on the first window size and the first window position.

In some embodiments, the apparatus further includes:
a first determining module, configured to determine, in response to a gesture operation for the video playing window, a window scaling ratio based on the gesture operation;
a second determining module, configured to determine a second window size based on the first window size and the window scaling ratio; and
a fourth display module, configured to display the video playing window on the upper layer of the out-battle scene interface based on the second window size and the first window position.

In some embodiments, at least one function control corresponding to the first video is displayed in the video playing window.

The apparatus further includes:
a third determining module, configured to determine a target control size of each function control based on the second window size, the target control size being positively correlated with the second window size.

The apparatus further includes:
a fifth display module, configure to display, in response to a trigger operation in the video playing window, each function control in the video playing window based on the control size.

In some embodiments, the apparatus further includes:
a fourth determining module, configured to determine, in response to a dragging operation for the video playing window, a second window position of the video playing window based on the dragging operation; and
a sixth display module, configured to display the video playing window on the upper layer of the out-battle scene interface based on the second window position and the first window size.

In some embodiments, the fourth determining module includes:
a second determining unit, configured to determine, in response to the dragging operation for the video playing window, central position coordinates of the video playing window in response to that the dragging operation stops, the video playing window moving with the dragging operation; and
a third determining unit, configured to determine, based on a display area at the central position coordinates, the second window position corresponding to the video playing window, the second window position being located at a screen corner position corresponding to the display area.

In some embodiments, the apparatus further includes:
a second control module, configured to stop displaying the video playing window in response to that a target application is switched from a foreground running state to a background running state, the target application being a program that displays the out-battle scene interface; and
a third playing module, configured to continue to play the first video through the video playing window in response to that the target application is switched from the background running state to the foreground running state.

To sum up, in the embodiment of the present disclosure, by providing a windowed video playing function for a video playing resource in an out-battle scene interface, a first video can be played in a video playing window. A feasible method is provided for a user to play a video during a game, and there is no need to keep a full-screen video playing interface at all times. Moreover, by playing the video in the video playing window, the influence on the user's related operation in the out-battle scene interface during video playing can be reduced. In addition, after entering a battle interface, the video playing window will be closed to avoid the influence of video playing on a game battle process.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

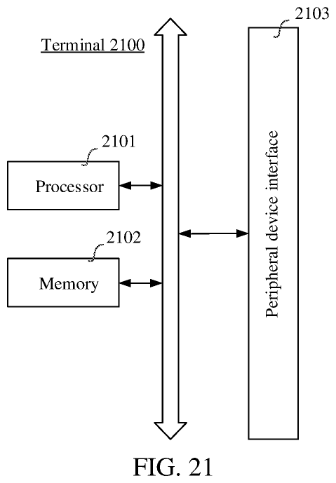

FIG. 21 is a structural block diagram of a terminal 2100 provided by one exemplary embodiment of the present disclosure. The terminal 2100 may be: a smart phone, a tablet computer, a moving picture experts group audio layer III (MP3) player, a moving picture experts group audio layer IV (MP4) player, a notebook computer, or a desktop computer. The terminal 2100 may also be named as a user equipment, a portable terminal, a laptop terminal, a desktop terminal and so on.

Generally, the terminal 2100 includes: a processor 2101 and a memory 2102.

The processor 2101 may include one or more processing cores, for example, a 4-core processor or an 8-core processor. The processor 2101 may be implemented in at least one hardware form of a digital signal processor (DSP), a field-programmable gate array (FPGA), and a programmable logic array (PLA). The processor 2101 may also include a main processor and a co-processor. The main processor is a processor configured to process data in a wakeup state, also called a central processing unit (CPU). The co-processor is a low-power processor configured to process data in a standby state. In some embodiments, the processor 2101 may be integrated with a graphics processing unit (GPU). The GPU is configured to render and draw the content that needs to be displayed on a display screen. In some embodiments, the processor 2101 may further include an artificial intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some embodiments, the non-transient computer-readable storage medium in the memory 2102 is configured to store at least one instruction, and the at least one instruction, when executed by the processor 2101, implements the video playing method provided by the method embodiments of the present disclosure.

In some embodiments, the terminal 2100 may include: a peripheral device interface 2103 and at least one peripheral device. The processor 2101, the memory 2102, and the peripheral device interface 2103 may be connected through a bus or a signal cable. Each peripheral device may be connected to the peripheral device interface 2103 through a bus, a signal cable, or a circuit board. Specifically, the peripheral device includes: at least one of a radio frequency circuit, a display screen, an audio circuit, and a power supply.

The peripheral device interface 2103 may be configured to connect the at least one peripheral device related to input/output (I/O) to the processor 2101 and the memory 2102. In some embodiments, the processor 2101, the memory 2102 and the peripheral device interface 2103 are integrated on a same chip or circuit board. In some other embodiments, any one or two of the processor 2101, the memory 2102, and the peripheral device interface 2103 may be implemented on a single chip or circuit board. This is not limited in this embodiment.

A person skilled in the art may understand that the structure shown in FIG. 21 constitutes no limitation on the terminal 2100, and the terminal may include more or fewer components than those shown in the figure, or some components may be combined, or a different component arrangement may be used.

The present disclosure also provides a computer-readable storage medium, having at least one instruction, at least one program, a code set or an instruction set stored thereon, the at least one instruction, the at least one program, the code set or the instruction set being loaded and executed by a processor to implement the video playing method provided in any of the above exemplary embodiments.

An embodiment of the present disclosure provides a computer program product, including computer instructions, the computer instructions being stored in a computer-readable storage medium, a processor of a computer device reading the computer instructions from the computer-readable storage medium, and the processor executing the computer instructions so that the computer device executes the video playing method provided in above optional implementations.

A person skilled in the art may understand that all or some of the steps of the above embodiments may be implemented by hardware, or may be implemented by a program instructing relevant hardware, the program may be stored in a computer-readable storage medium, and the storage medium may be a read-only memory, a magnetic disk, an optical disc, or the like.

The foregoing descriptions are merely optional embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A video playing method, performed by a terminal, the method comprising:
displaying a windowed playing control in an out-battle scene interface, the out-battle scene interface being a scene interface of a game other than a battle interface of the game;
displaying, in response to a trigger operation on the windowed playing control in the out-battle scene interface, a video playing window on an upper layer of the out-battle scene interface, a first video being played in the video playing window; and
closing the video playing window when switching from the out-battle scene interface to the battle interface.

2. The method according to claim 1, wherein the closing the video playing window when switching from the out-battle scene interface to the battle interface comprises:
in response to that a battle instruction is received, displaying a battle participating interface and closing the video playing window.

3. The method according to claim 2, further comprising:
obtaining a playing progress of the first video in the video playing window in response to that the battle instruction is received; and
in response to that a battle exit instruction is received, opening the video playing window, and playing the first video in the video playing window according to the playing progress.

4. The method according to claim 1, wherein the closing the video playing window when switching from the out-battle scene interface to the battle interface comprises:
in response to that a battle spectating instruction is received, displaying a battle spectating interface, and closing the video playing window.

5. The method according to claim 4, further comprising:
obtaining a playing progress of the first video in the video playing window in response to that the battle spectating instruction is received; and
in response to that a battle spectating exit instruction is received, opening the video playing window, and playing the first video in the video playing window according to the playing progress.

6. The method according to claim 1, wherein the displaying, in response to a trigger operation on the windowed playing control in the out-battle scene interface, a video playing window on an upper layer of the out-battle scene interface comprises:
obtaining, in response to the trigger operation on the windowed playing control in the out-battle scene interface, through a video calling interface, a first video stream and first video related information corresponding to the first video; and
playing the first video in the video playing window based on the first video stream and the first video related information.

7. The method according to claim 1, further comprising:
in response to a trigger operation in the video playing window, displaying a video switching control; and
switching and playing a second video in the video playing window in response to a trigger operation on the video switching control.

8. The method according to claim 7, wherein the switching and playing a second video in the video playing window in response to a trigger operation on the video switching control comprises:
transmitting, in response to the trigger operation on the video switching control, a video switching instruction through a video calling interface, the video switching instruction being used for obtaining a second video stream and second video related information corresponding to the second video;
obtaining the second video stream and the second video related information through the video calling interface; and
playing the second video in the video playing window based on the second video stream and the second video related information.

9. The method according to claim 1, wherein the displaying, in response to a trigger operation on the windowed playing control in the out-battle scene interface, a video playing window on an upper layer of the out-battle scene interface comprises:
determining, in response to the trigger operation on the windowed playing control in the out-battle scene interface, a first window size and a first window position of the video playing window, different display screen sizes corresponding to different first window sizes, and the first window size being smaller than the display screen size; and
displaying the video playing window on the upper layer of the out-battle scene interface based on the first window size and the first window position.

10. The method according to claim 9, further comprising:
determining, in response to a gesture operation for the video playing window, a window scaling ratio based on the gesture operation;
determining a second window size based on the first window size and the window scaling ratio; and
displaying the video playing window on the upper layer of the out-battle scene interface based on the second window size and the first window position.

11. The method according to claim 10, wherein at least one function control corresponding to the first video is displayed in the video playing window; and the method further comprises:
determining a control size of a function control based on the second window size, the control size being positively correlated with the second window size; and
displaying, in response to a trigger operation in the video playing window, the function control in the video playing window based on the control size.

12. The method according to claim 9, further comprising:
determining, in response to a dragging operation for the video playing window, a second window position of the video playing window based on the dragging operation; and
displaying the video playing window on the upper layer of the out-battle scene interface based on the second window position and the first window size.

13. The method according to claim 12, wherein the determining, in response to a dragging operation for the video playing window, a second window position of the video playing window based on the dragging operation comprises:
determining, in response to the dragging operation for the video playing window, central position coordinates of the video playing window in response to that the dragging operation stops, the video playing window moving with the dragging operation; and
determining, based on a display area at the central position coordinates, the second window position corresponding to the video playing window, the second window position being located at a screen corner position corresponding to the display area.

14. The method according to claim 1, further comprising:
stopping displaying the video playing window in response to that a target application switches from a foreground running state to a background running state, the target application being a program that displays the out-battle scene interface; and
continuing to play the first video through the video playing window, in response to that the target application switches from the background running state to the foreground running state.

15. A video playing apparatus, comprising:
at least one processor and at least one memory, the at least one memory storing at least one program, and the at least one program being loaded and executed by the at least one processor to implement:
displaying a windowed playing control in an out-battle scene interface, the out-battle scene interface being a scene interface of a game other than a battle interface of the game;
displaying, in response to a trigger operation on the windowed playing control in the out-battle scene interface, a video playing window on an upper layer of the out-battle scene interface, a first video being played in the video playing window; and
closing the video playing window when switching from the out-battle scene interface to the battle interface.

16. The apparatus according to claim 15, wherein the closing the video playing window when switching from the out-battle scene interface to the battle interface comprises:
in response to that a battle instruction is received, displaying a battle participating interface and closing the video playing window.

17. The apparatus according to claim 16, wherein the at least one processor is further configured to implement:
obtaining a playing progress of the first video in the video playing window in response to that the battle instruction is received; and
in response to that a battle exit instruction is received, opening the video playing window, and playing the first video in the video playing window according to the playing progress.

18. The apparatus according to claim 15, wherein the closing the video playing window when switching from the out-battle scene interface to the battle interface comprises:
in response to that a battle spectating instruction is received, displaying a battle spectating interface, and closing the video playing window.

19. The apparatus according to claim 18, wherein the at least one processor is further configured to implement:
obtaining a playing progress of the first video in the video playing window in response to that the battle spectating instruction is received; and
in response to that a battle spectating exit instruction is received, opening the video playing window, and playing the first video in the video playing window according to the playing progress.

20. A non-transitory computer-readable storage medium, having at least one program stored thereon, the at least one program being loaded and executed by at least one processor to implement:
displaying a windowed playing control video in an out-battle scene interface, the out-battle scene interface being a scene interface of a game other than a battle interface of the game;
displaying, in response to a trigger operation on the windowed playing control in the out-battle scene interface, a video playing window on an upper layer of the out-battle scene interface, a first video being played in the video playing window; and
closing the video playing window when switching from the out-battle scene interface to the battle interface.
